(19) United States
(12) Patent Application Publication
(10) Pub. No.: US 2025/0272055 A1
(43) Pub. Date: Aug. 28, 2025

(54) System and Method for Recording, Transmitting, Organizing, Retrieving and Using Structured Data Records Using Voice

(71) Applicant: Vocal Technologies Ltd, Vancouver (CA)

(72) Inventor: James Stewart, Vancouver (CA)

(21) Appl. No.: 18/892,302

(22) Filed: Sep. 20, 2024

Related U.S. Application Data
(60) Provisional application No. 63/556,874, filed on Feb. 23, 2024.

(51) Int. Cl. G06F 3/16; G10L 15/22

(52) U.S. Cl. CPC G06F 3/167; G06F 3/165; G10L 15/22; G10L 2015/223

(57) ABSTRACT

A system and method for transmitting user utterances to an output destination based on detected triggers. The system includes processing circuitry and memory with instructions to detect a trigger from a set of predefined triggers, such as audible commands or manual interactions. Upon detecting a trigger, the system receives a user utterance and transmits it to a destination determined by the trigger. The system also supports generating associated data, transforming user utterances into different formats, and mapping them to specific fields. Additional features include configuring multiple triggers, retrieving stored utterances based on retrieval triggers, aggregating retrieved data, and providing quizzes using machine learning models. The invention offers a versatile, voice-activated interface for data entry, management, and retrieval, allowing users to customize how information is processed and where it is sent or stored.

### CROSS-REFERENCE TO RELATED APPLICATIONS

This application claims the benefit of U.S. provisional patent application No. 63/556,874, filed on Feb. 24, 2024, the contents of which is incorporated by reference in their entirety.

### BACKGROUND

### Field of the Invention

The present invention relates generally to data transmission and processing, and, in particular, to a system and method for transmitting user utterances to an output destination based on detected triggers.

### Scope of the Prior Art

Use of dictation as a form of managing information is primitive. Although it is possible to send computers commands and to dictate texts and emails using voice, these forms of voice-activated interface are rudimentary and unsophisticated. The highly limited use of voice as a means of data entry, management and retrieval creates major limitations.

Presently, it is near impossible to post dictated text to social media. Consequently, posting information to Twitter, Instagram or Facebook requires use of a keyboard, opening webpages or apps, typing content manually, or adding whatever supplemental data one sees fit. A User cannot perform these tasks by using voice alone.

Similarly, if someone wants to add information to a database using just their voice, it is exceptionally difficult to place dictated text into an appropriate column of that database without opening the database on a laptop or personal computer then using a keyboard. This process is cumbersome, time-consuming and cannot be done easily while mobile.

In addition, even if you could dictate information then send it to email, text, social media or a database, there is presently no way of organizing dictated information automatically after it's entered via dictation. There is no program that allows us to succinctly tell a smartphone or computer where to send or store our dictation, or what to do with it after we finish dictating.

Moreover, while we can take voice memos or dictate information into some apps, the experience varies significantly from one app to the next, is badly integrated if at all across apps, and doesn't allow Users to use their voice to organize and manage information nearly as much as they could given technological possibilities.

For example, if someone is sending themself a note-to-self or reminder, there is presently no way of categorizing those reminders by keyword, subject-area or location of entry. One cannot easily send these notes-to-file to a particular database that is shared with a team, or specifying whether the note-to-self is sent as an original audio file, transcribed text using voice-to-text or both.

Similarly, there is currently no way to automatically add supplemental information to dictated notes, like entry date, geo-locations, or metadata that relates to the topic the User is dictating notes about. If a User is entering notes about a Youtube video or audiobook into a database, they will have to copy and paste the video URL or book title into the database manually. How time-consuming!

These limitations have serious consequences. At present, for instance, it is very difficult to take notes on audio material, such as audiobooks, podcasts or information from videos using just voice commands. To take organized notes on these forms of information requires manual entry at a computer or with a pen on a pad. Opportunities for dictating organized notes are few.

So, while we can all listen to audio material while out walking, on an exercycle, while doing the dishes, or driving to work, there is presently no way of taking notes on the audio-material we are listening to using just voice. Even if we could, the position in the audio source, the time when we make the audio note cannot be automatically included in our note.

In addition, although we often want to dictate information without referring to audiobooks, podcasts, or videos, it is also clear that when we do want to use our voice to take notes on information we acquired from these audio/audiovisual sources, there is no way of including an excerpt of the audio we were listening to in our notes automatically. This serious limits the utility of our notes.

Moreover, there is no way of seamlessly retrieving, presenting and reminding ourselves of the information we have dictated after that process is complete. Many empirical studies confirm that learning requires a variety of ways of retrieving information at regular intervals, from creating mind maps to question and answer modules, but presently no app offers these features let alone in an integrated manner.

Furthermore, it is not currently possible for Users to review or replay their dictated records and/or the excerpts they capture from the audio they are listening to through voice commands alone. One cannot presently say to an app, “play me the note I took when I was in New York, about offshore tax shelters,” then have your own voice note about this topic replayed to you. Likewise, you cannot ask an app using just your voice to replay your dictated notes that you made between particular dates, or about specified authors, books, or subjects.

While we certainly believe that a substantially more sophisticated tool for creating, organizing and retrieving information using voice like that we describe here will revolutionize the way we interface with computers, keyboards might still have some utility. A User could, for instance, dictate notes about a document or email they are reading on a PC or laptop without changing applications, which is presently difficult if not impossible to do.

All in all, the byzantine relationship between voice and information creation and management is a major problem that produces great inefficiencies, seriously inhibits learning, keeps people sitting behind desks despite the well-documented negative health implications of doing so for long periods of time, precludes multitasking in a variety of important areas, and prejudices the vast numbers of people for whom reading is either very difficult or impossible.

This invention solves, partially or in whole, each of these problems.

### SUMMARY

The present disclosure satisfies the foregoing needs by providing, inter alia, a system and method for transmitting user utterances to an output destination.

The system includes processing circuitry and memory that store instructions for detecting triggers from a set of predefined triggers. Once a trigger is detected, the system can receive a user utterance and transmits it to an output destination determined by the detected trigger. This flexible system allows for a range of triggers, such as audible commands or manual interactions, and supports multiple types of data output destinations.

The invention also encompasses various methods for refining how data is managed, transformed, and transmitted. For instance, when a trigger is detected, the system can provide a prompt to the user and receive the user's utterance in response. It can also generate associated data based on the detected trigger and transmit this data to the output destination. Associated data can be received when it is generated by the system. Additionally, the system can receive data transformation rules and mapping specifications, enabling the transformation of user utterances from a source format to a target format appropriate for the destination.

Moreover, the system allows for configuring multiple triggers, each associated with specific prompts, generated data, and output destinations, providing extensive customization capabilities. The system also supports retrieval of data based on detected retrieval triggers, allowing for a variety of retrieval operations, including aggregating retrieved utterances, transforming them into different formats, or generating summaries or interactive quizzes using machine learning models. Automatic retrieval conditions can be set by the user to retrieve data based on predefined criteria, further enhancing the flexibility and functionality of the system.

This invention can be implemented as a non-transitory computer-readable medium containing instructions that enable the described functionalities, offering a robust solution for managing, transforming, and transmitting data in a highly configurable and user-friendly manner.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 is a UML User Diagram describing the interactions between the User and the various components of the proposed invention, including interactions with external platforms like databases, email, text and social media.

FIG. 2 is a UML Deployment Diagram describing the hardware infrastructure of our preferred embodiment of this invention as well as the software modules that will run within the execution environment of this deployment.

FIG. 3 is a UML Class Diagram that depicts the composition of Vocal Modules within a Module Library, including the mandatory attributes with selection, the imposed mandatory attributes and the optional attributes that make up Vocal Modules.

FIGS. 4a-4b are a UML Sequence Diagram showing the sequencing of the optional system reminding Users to review their dictated records, the different forms of reminder, the various ways of initiating audio record retrieval and the range of ways of performing record review.

FIG. 5 is a UML Class Diagram showing the constitutive elements of both visual and audio record retrieval within the invention, as well as the interface between the two systems and the optional reminders that prompt Users to review their audio records.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of systems and methods for transmitting user utterances to an output destination, it will be recognized by those of ordinary skill that the present disclosure is not so limited. In fact, the principles of the present disclosure described herein may be readily applied to data processing and transmission in general.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

### 1. User Experience

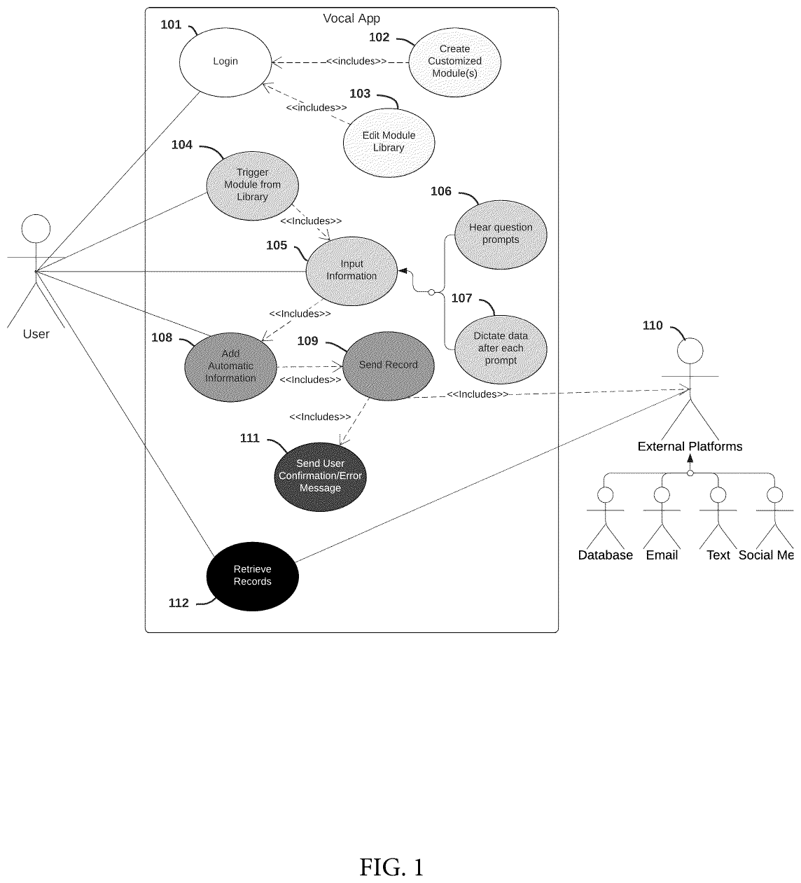

FIG. 1 is a UML User Diagram that provides a high-level overview of the system's functionality and the User's perspective, facilitating a clear understanding of User requirements and system behaviors. This diagram helps provide an overview of the methods and processes envisaged in this provisional patent application from a User's perspective.

The User first logs onto the App 101, then creates customized modules 102, 103 that he or she can later invoke in order to dictate structured data records. As we discuss in more detail momentarily, these modules allow the User to designate different triggers, output destinations and automatic information to Modules 301.

Having logged in and created a Module within the Module Library, the User can then trigger that or any other Module from the Module Library 104 in order to dictate a structured data record and send that record to output destinations previously assigned in the Module.

The User begins by triggering a module from the Module Library 104, using voice, keyboard or button triggers. In our preferred embodiment, the invention asks the User a question 106 then records the User's dictated answer 107 to it, looping this cycle until the Module has asked all questions it contains and obtained the User's dictated response for each question.

The App then adds the Automatic Information 108 that the User specified when setting up the Module 102. The types of Automatic Information include date, time, geolocation, metadata about the source the User is listening to, or an excerpt from the audio being played, to name but a few forms of Automatic Information 304. Automatic Information can be referred to as associated data.

The invention then sends the package of information obtained from combining the dictated responses to prompt questions and automatic information as a structured data record 109 to the External Platforms 110 that the User elected for the Module 102. The invention then says a phrase such as “Done!” to the User to confirm that the record was successfully created and delivered or provides a spoken error message 111.

Then, the User can retrieve records 112 from the External Platforms 110 through a set of processes described in greater detail under sub-section 4 below, entitled Retrieval.

### 2. System Overview

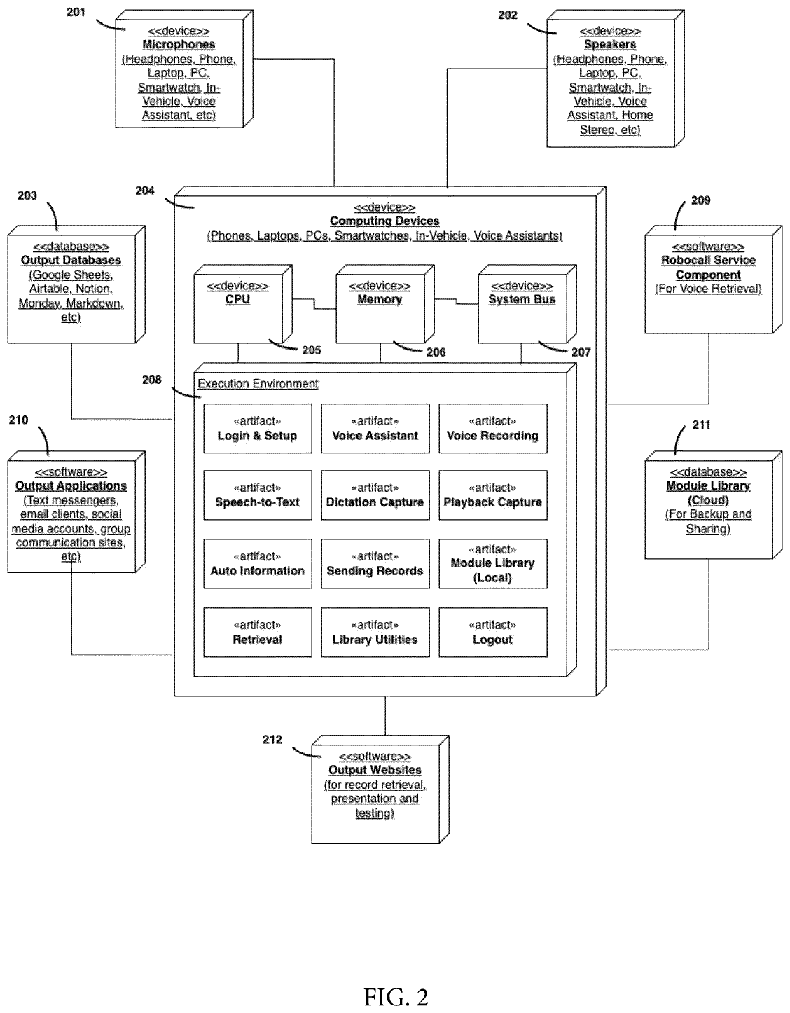

FIG. 2 is a UML Deployment Diagram describing the hardware infrastructure and software components that will run within the execution environment to create the user experience described above.

This invention can run on a range of computing devices 204, including but not limited to Smartphones, Laptops, PCs, Smartwatches, In-Vehicle computers, and Voice Assistants. In order to execute these operations, these computing devices require a Central Processing Unit (CPU) 205 to perform operations within the Execution Environment 208, a Memory device to store Dictation Capture, Playback Capture and other data 209, and a System Bus to connect the various components of the system, such as the CPU 205, Memory 206, and peripheral devices 201, 202, 203, 209, 210, 211, 212.

The system must connect to one or more microphones 201. The system could operate with headphones connected via bluetooth, a built-in microphone within a smartphone, laptop, PC, or Smartwatch, a microphone contained within an automobile's controls, or a Voice Assistant like Alexa or Google Assistant. Microphones must be able to send signals to the Computing Device(s) 204.

The system must also connect to speakers 202. Speakers could include headphones connected via bluetooth, built-in speakers within a smartphone, laptop, PC, or smartwatch, speakers contained within an automobile, or a Voice Assistant like Alexa or Google Assistant. Speakers must be able to receive signals from the Computing Device(s) 204.

The system must connect to a database 203. This database might include one created specifically and uniquely for records produced by this invention, or could couple with independent third parties who already offer web-based databases this invention can connect to via Application Programming Interfaces (APIs), such as Google Sheets, Airtable, Notion, Monday, or Markdown.

Some embodiments require that the system connect to output applications 210, including text messengers, email clients, social media accounts, group communication websites like Slack and other web-based platforms for sharing text such as Google Docs, Google Sheets, Notion, Markdown, and Obsidian, for example. These connections can take place within apps on the Computing Device(s) 204 or via Application Programming Interfaces (APIs) to web-based software 212.

One embodiment of the invention requires the system to connect to a Robocall Service Component 209. This component acts as an audio reminder to Users to review records after a specified amount of time since the records were made has passed, at particular intervals, or on designated dates. The Robocall Service Component 209 allows the system to deliver a voice-based reminder to the User, furthering the use of voice as an input to, an output from and a means of interaction with the system.

The System also involves a cloud-based system for backing up and sharing Vocal Modules within a Module Library 211. While the Execution Environment 208 contains a local Module Library from where Modules are run by the Computing Device 204, a copy of this Module Library is required in the cloud to preserve the security of a User's library, to prevent against data loss if a Computing Device 204 is lost or stolen, and to facilitate the sharing of Vocal Modules which will save Users time and energy.

### 3. Module Composition

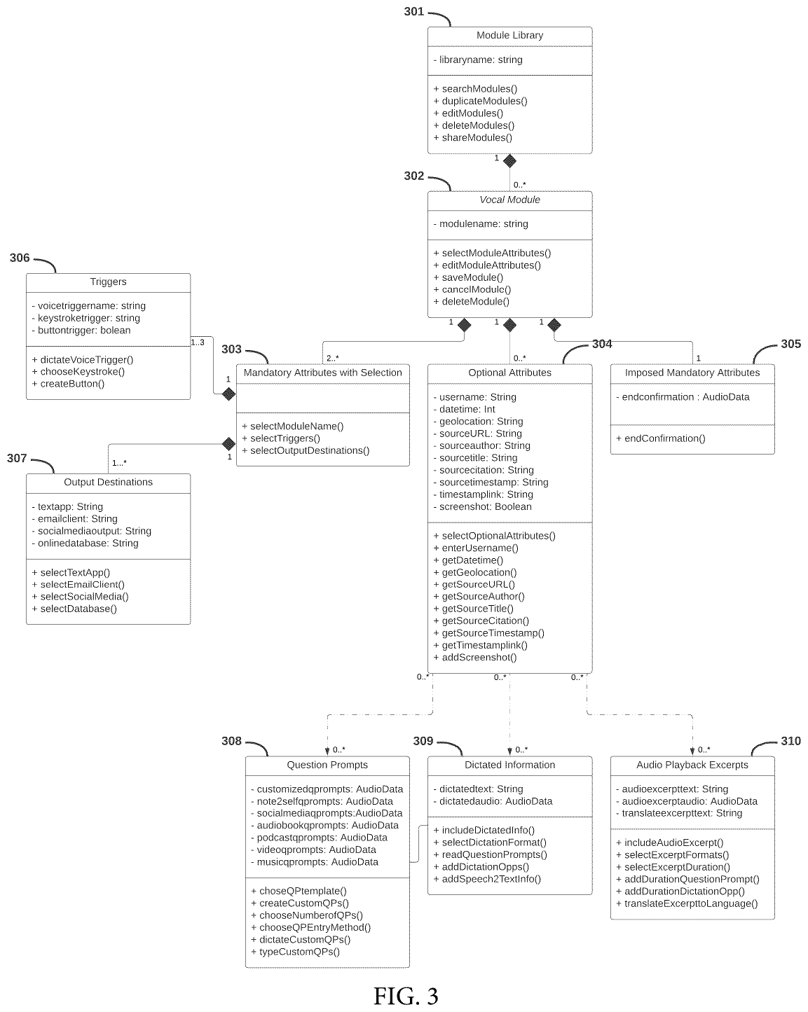

FIG. 1 refers to creating customized Module(s) 102 and editing the Module Library 103 as initial steps for the User in using this invention. Similarly, FIG. 2 refers to the local and cloud-based Module Libraries, which contain Vocal Modules 208, 2011. To best describe the attributes of these Modules within the invention, FIG. 3 sets out a UML Class diagram that shows the classes that make up a Vocal Module, the attributes particular to each class and the methods the invention employs.

Each User has a single Module Library 301, which contains as many Vocal Modules 302 as the User has created or imported into their Library. The Module Library 301 is a repository of the Vocal Modules that are used to create structured data records using voice. Users can edit the Module Library 301 in a number of ways, as demonstrated by the methods listed in 301. These include searching the Module Library for particular Vocal Modules, duplicating Vocal Modules, Editing Vocal Modules including those duplicated, deleting Vocal Modules the User no longer wants, and sharing in the sense of both importing and exporting Modules 301 with others.

Each Vocal Module 302 can have three sets of attributes:

First, the Module has Mandatory Attributes with Selection 303, which means that the User must assign values to a set of mandatory variables within each Module 302. Under this heading, Users must assign each Module a distinct name 303, one or more triggers 306 to set how the User can run the particular Module, and one or more Output Destinations 307 to specify where structured data records produced by the Module will be sent and stored. Users can choose to assign each Module a voice, keystroke and/or button trigger 306. Output destinations include text messengers, email clients, social media platforms, and online databases 306.

Second, Users can choose to add a series of Optional Attributes 304 to a Vocal Module, although the User is not obliged to do so. The User can configure a Vocal Module to automatically include a range of information with each dictated record the User makes using the Module. This automatic information can include the User's name, the time and date the record was made, the geo-location where the record was made, the URL of the source the User is making records about, the author of the source the User is making records about, the full citation of the source the User is making records about, and/or a timestamp of the point in a background audio when the Module was triggered which can operate as a hyperlink to that point in the audio file 304.

There are other forms of Optional Attributes a User can assign to a Vocal Module too 308, 309, 310. The User can assign Question Prompts 308 to a Module, either by choosing templates of Question Prompts that are specific to the type of records they want to make or by creating customized Question Prompts 308. The User can choose any number of Question Prompts, to enter the Question Prompts in the Module by dictation or typing, and to have the invention replay the User's own voice or to regenerate the voice as someone else's 308. It is not necessary for a Module to include Question Prompts, but if they are included, they have a relationship with Dictated Information 309, since every Question Prompt must be followed by a dictation opportunity 309. Dictated information can be stored as original audio or as text after voice to text conversion 309.

Users can also choose to add Audio Playback Excerpts 310 as part of their Optional Attributes 304. If Users elect to include an excerpt of the audio they were listening to immediately before they triggered the invention, they can also choose to have the excerpt captured in text and/or audio format, and opt to have a constant amount of audio captured automatically when each record is made or to add a Question Prompt requiring the User to dictate an amount of time to capture between 1 and 180 seconds each time the Module runs 310. Dictated Information 309 is optional because one embodiment of the invention involves its use as a tool to capture audio playback excerpts and other Automatic Information without the User dictating any utterance.

Third, Users must include Imposed Mandatory Attributes within each Module they create. This class involves attributes that are required for all Modules, with limited to no choice offered Users about their inclusion or content. Presently, the only Imposed Mandatory Attribute required for each Vocal Module is a statement that the Module has successfully completed or that an error occurred 305. This element, which attaches to each Module, is the final step in a Module's sequence of tasks. It serves to confirm whether the User's dictated text was recorded and transmitted as requested. For the sake of User experience, the simple confirmation is mandatory for all Modules, and the phrase “Done” or “Error” are sufficiently simple to adopt these words as constants for this attribute.

### 4. Retrieval System

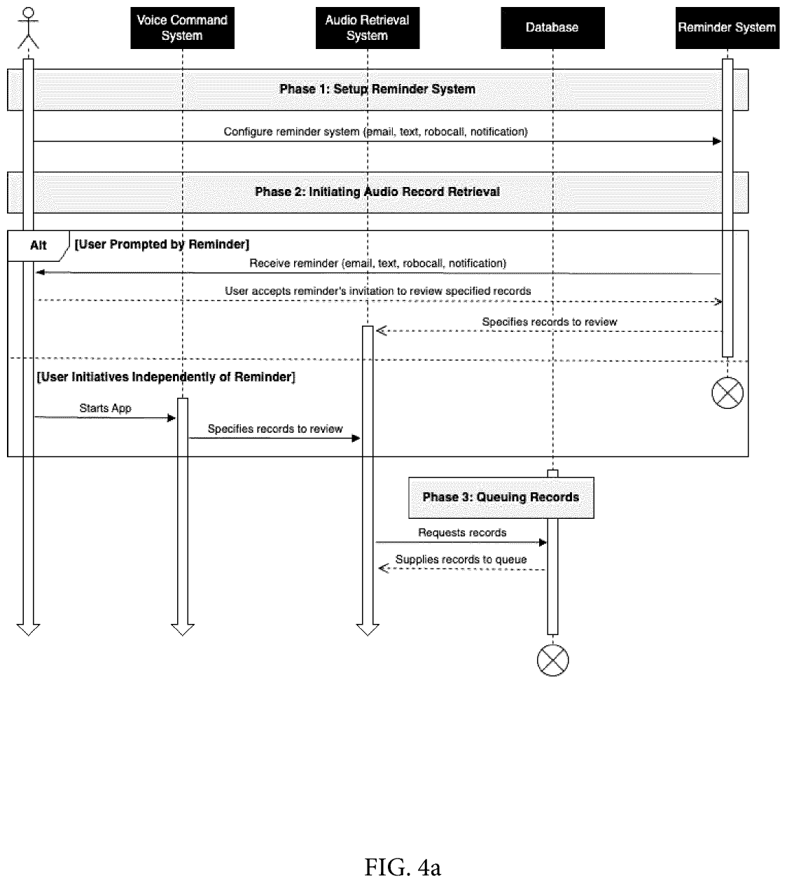

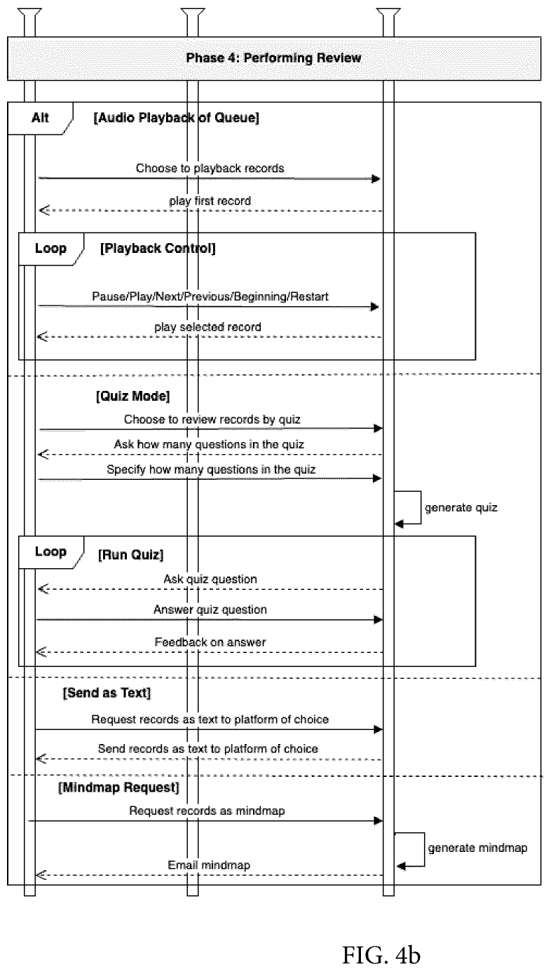

This provisional patent application contains two diagrams that describe the invention's record retrieval system. FIGS. 4a-4b are a UML Sequence Diagram depicting the system's retrieval process over time, as the User, the Voice Command System, the Audio Retrieval System, the Database and the Reminder System interact. There are four phases depicted in FIGS. 4a-4b. In Phase 1, the User sets up a reminder system using email, text, a robocall system or notifications. Although the User is not obliged to set up a Reminder System, if the User chooses to, they can select one or more of these forms of reminder, specify a specific date, a regular interval or period after completion to receive reminders to retrieve and review records the User created.

In Phase 2 of FIGS. 4a-4b, the User initiates use of the Audio Record Retrieval system. The User has two options. In the first option, the Reminder System sends a reminder to the User, in the form and at the time the User selected during Phase 1 Setup. The User can choose to accept the Reminder's invitation to review specific records by clicking on a link in an email, saying yes to a robocall or pressing a button in a notification 508. If the User accepts the invitation, the Reminder System will specify records for the Audio Retrieval System to review with the User. In the second option, the User initiates the Audio Retrieval System independently of a reminder by starting the invention autonomously and specifying the records the User wants to review using their voice.

In Phase 3 of FIGS. 4a-4b, the system queues the records selected through either the first or second options in Phase 2 for retrieval. The process involves the Audio Retrieval System requesting the records specified by either the Reminder System or the User directly from the Database of structured data records that were created using voice. As a result of this process, the Database supplies the Audio Retrieval System with a set of records that form a queue the User will navigate through as they review their records in Phase 4.

After Phase 3 creates the queue of records, Phase 4 provides the User with four options they can select using their voice. As Phase 4 of FIGS. 4a-4b shows, Users can have the invention play back their records in the queue. If the User chooses to play their records in the queue, then the system plays the first record. During playback, Users can pause, play, move to the next record, move to the previous record, go back to the beginning of the record queue or restart the selection process under the second option in Phase 2 of FIGS. 4a-4b. By these processes, Users can listen to their dictated records, including automatic information and audio playback excerpts included in them. During Phase 4, Users can also choose to create a Quiz based on the information in the record queue. After the User selects a quiz, the invention will ask them how many questions they want to include in the quiz. The User then nominates a number of questions for the invention to ask them. At that point, the invention uses artificial intelligence and Large Language Models (LLMs) to generate the number of questions the User has specified. After each question, the User is provided an opportunity to dictate an answer. The invention analyses the answer the User provides, then offers feedback on the accuracy of the User's answer. This process loops until the User restarts using voice commands or completes the quiz.

During Phase 4, the User can also choose to have the invention send information contained in the record queue as visual information. There are several options here. In the first option, the User can choose to have the invention send the records as a table containing text to their platform of choice, including via email, text, social media, website or other software capable of displaying text. In the second option, the invention can use artificial intelligence to create a mindmap that displays the User's notes visually, then send this mindmap to the User's platform of choice, including via email, text, social media, website or other software capable of displaying images. Different embodiments of the invention involve other forms of auditory, textual and visual presentation.

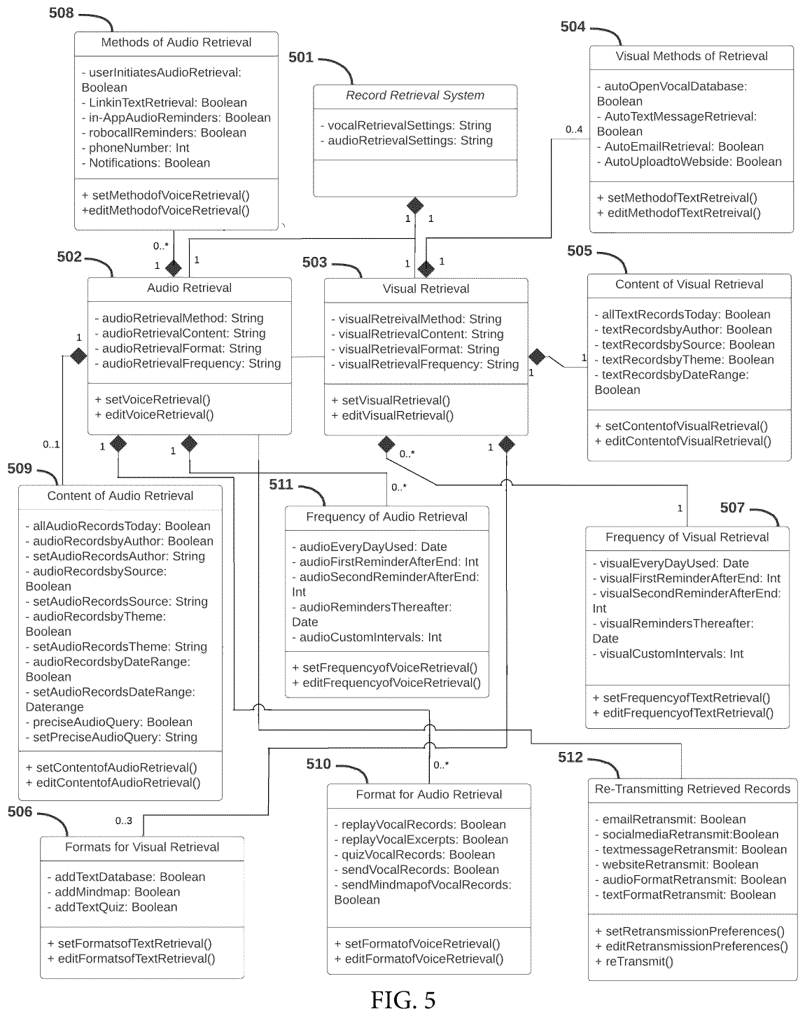

FIG. 5 is a UML Class Diagram that show the record retrieval system described above also. In this diagram, the overall Record Retrieval System 501 is made up of Audio Retrieval 502 and Visual Retrieval 503. Both Audio Retrieval 502 and Visual Retrieval 503 allow the User to choose the method, content, form and frequency of reminders to review the User's dictated records. Under both forms of retrieval, Users can also elect to retransmit records they have reviewed, by text message, email, social media platform, website or any other means of sharing data between computers 512.

For Visual Retrieval 503, the User can choose to have the invention automatically open the database storing their dictated records, or automatically text, email or upload the records in the record queue 504 to addresses the User elects. Visual Retrieval can involve all records, all records produced today, all records produced by a particular author, all records involving a particular source or theme, or all records from a specified date range 505. Users can choose to retrieve records visually as a text table, a mindmap or a written quiz 506, and they can receive these visual reminders every date, on the first day after the User completes notes on a particular audio source, and at specified intervals 507. The Visual Reminder system can be set up within Modules for records created by particular Modules and/or set up as part of universal settings for reminders that draw upon notes created by a variety of different Modules.

For Audio Retrieval 508, the User can choose to initiate the audio retrieval system by themselves, independently of the reminder system, by clicking a link in a text-based reminder, by accepting in-app audio reminders, by accepting an invitation in a robocall reminder or from a visual notification 508. Audio Retrieval can involve all records, all records produced today, all records produced by a specified author, all records by source, all records by theme, all records from a specified date range, or records obtained from a specific query 509. Unlike the Visual Reminder System, which is pre-configured as part of the Reminder System see FIGS. 4a-4b, in Phase 1, the Audio Retrieval System allows the User to use their voice to specify the search criteria and interact with the Audio Retrieval System 508. As part of the Audio Retrieval System 508, Users can also issue a command using their voice to retrieve records visually as a table, a mindmap or a written quiz 506, and they can use their voice to order these visual reminders every date, on the first day after the User completes notes on a particular audio source, and at specified intervals 507.

The invention's operation can be divided into distinct phases: the setup, activation, input, transmission, and post-entry phases. We discuss each in turn:

### 1. Setup Phase:

In a preferred embodiment, this invention requires a number of setup steps to achieve the advantages we set out at the beginning of this application. In this preferred embodiment, we run the invention using an iPhone as the Computing Device 204. We also connect the iPhone to wireless headphones using Bluetooth 202. These headphones also contain a microphone 201, which allows the User to activate the invention by using their voice and to dictate records when prompted by the invention without accessing the iPhone directly. The iPhone running the invention requires a wifi connection, either through a localized internet provider or via cellular data. In this preferred embodiment, Users need to enable “Hey Siri” in the iPhone's settings as part of the setup.

After logging in 101, the User creates a Module 102 and assigns the Module the name “Brothers Karamazov.” The User also configures the Module to include the phrase “Brothers Karamazov” as the trigger word 306, sets the output destination for records created by the Module as a Notion database 307 using an Application Programming Interface (API), then sets up this database with columns for each of the types of information this invention can produce. The User configures the Module to include template Question Prompts for an audiobook 308 that map onto the appropriate columns in the Notion database. This template also includes the following Automatic Information 108, 304: author name, audiobook title, timestamp, geo-location, date and time of entry. Then the User manually enters the author's name (Fyodor Dostoevsky) and title of the audiobook (Brothers Karamazov) into those fields within the Module, so that this information is entered automatically every time the User makes a record about the audiobook. The User also selects an option in the Module configuration that allows them to capture a constant thirty seconds of the audio playback every time they made a record 310, and to save their dictations and the audio excerpts in both original audio format and as text created using speech-to-text technology 310. The Notion database has separate columns for each of these formats.

### 2. Activation Phase:

In this best mode or preferred embodiment, Users activate the invention by first saying “Hey Siri” 104 to the iPhone, then when prompted, stating the word “Vocal” followed by the trigger word for the Module they want to invoke, which in this embodiment is “Brothers Karamazov.” Together, the User says “Hey, Siri”, pauses for the prompt, then says “Vocal-Brothers Karamazov.” This process runs the Brothers Karamazov Module within the invention, thereby initiating the series of Question Prompts 308, dictation opportunities 309, automatic information 304, 310 and transmission procedures 305 that post this information to the Notion database as designated in the Brothers Karamazov Module. This activation process also pauses whatever audio was playing prior to the invention's activation, which means that the User will not miss aspects of the audio information that was playing while dictating notes about it.

### 3. Input Phase:

In this best mode or preferred embodiment, Users respond to each of the Question Prompts the invention asks of them, drawing on the set of Question Prompts assigned to the Module during the Setup Phase. In this embodiment, the only Question Prompt is: “What are your notes on Dostoevsky's Brothers Karamazov?” After the invention says this sentence, the User is prompted to dictate a response that will make up part of their record, which in this embodiment, is stored in a Notion database. In this embodiment, the dictated information is set to complete and move to the next question if there is one until there are no more questions after a short silence in audio input, obviating the need for Users to physically click a button to show they have finished dictating text after each question. In this embodiment, there is only one question prompt so the input phase ends after the User dictates their response to this one question prompt. The invention stores the dictated response and the accompanying automatic information specified in the Module during the Setup Phase in memory in anticipation of the transmission phase, which we describe next.

### 4. Transmission Phase:

In this preferred embodiment, the information that is input by the User and generated by the invention through the Input Phase is automatically transmitted to a Notion database the User has created. This is one embodiment of process 109, which provides for a range of alternatives we address in the next part of this patent application. Notion is an online database, one type of External Platform 110 our invention couples with. We have described the process of connecting the invention to Notion through the use of an Application Programming Interface (API) in the Setup Phase of this application. In essence, the invention assigns each of the areas of information that make up the structured record to a particular field in a designated Notion database, then instantaneously transmits this information along with other Automatic Information to the database once the Input Phase is complete.

### 5. Ending Phase:

In this best mode or preferred embodiment, the invention speaks the word “Done” as a confirmation to the User 111, 305 once the information is transmitted to Notion, which is the External Platform 110 we use in this embodiment. This spoken confirmation to the User 111, 305 serves to assure them that the note taking process is complete and that there was no error in performing this operation. In addition, after the invention speaks “Done” it ends itself and restarts whatever audio was playing prior to the activation. This automatic restart allows the User to pick up where they left off with audio information they were listening to, again avoiding the need for the User to press a button or icon on the iPhone manually.

### 6. Retrieval Phase:

The Retrieval Phase includes but is not limited to accessing, searching, retrieving, processing, organizing and sharing information contained in records. The records may or may not be produced by this invention. In this preferred embodiment, the invention couples with Notion, but there are numerous alternatives presented within the diagrams appended to this provisional patent application and discussed further under alternative embodiments below. In this preferred embodiment, the User chooses a form of Visual Retrieval 503 that sends the User an email with all the records they have entered by Russian novelists. The User configures the reminder to send this email to the User every three months 507, as a table and mindmap created by artificial intelligence after analyzing the User's records 506. The email to the User also contains a button the User clicks to access Audio Retrieval of these same records 508. After pressing this button within the email reminder, the User initiatives the Audio Retrieval System 502, which allows the User to play audio records on this specified topic including the User's dictations, audio playback excerpts and other elements of the record 509. As was the case when the User input these records, the User can review them while mobile, when driving, during exercise or in the course of performing other menial tasks.

As demonstrated by FIGS. 1-5, there are multiple alternative embodiments of this invention in each of the five phases of its functioning. Below we set out a non-exhaustive list of some of these alternative embodiments:

### Alternative Setup Phase:

As an alternative to best mode or preferred embodiment, this invention could also be set up with a range of speaker/microphone combinations other than headphones. The invention could operate with speaker/microphone combinations in smartwatches, laptop or desktop computers or on a mini-computer like the Raspberry Pi. In addition, the invention could work on voice-activated home assistants like Amazon Echo or Google Assistant or speaker/microphone combinations in automobiles. Speakers and microphones would not need to be co-located in the same device either. A User could dictate records into a microphone then retrieve these records at a later time on a different device, by using a phone to record and a home speaker to playback for example or by viewing the notes in text form on a laptop. These are but a small selection of the alternative embodiments for connecting microphones and speakers to the system.

A number of alternative embodiments are also possible for the creation of Modules in the Setup Phase. Instead of creating a Module using a template, Users could duplicate then edit a pre-existing Module in the Module Library 103, 301. This would save time and avoid re-entering data unnecessarily. Alternatively, the User could create an entirely customized series of Question Prompts or avoid having Question Prompts or dictation entirely, instead using the invention to just capture excerpts of audio playback and other Automatic Information whenever the Module runs. This embodiment will be especially useful in places like gyms or on public transport, where User's may prefer not to dictate notes for privacy reasons. Similarly, either manually or using AI, Users could enter metadata for fields within Modules automatically, drawing relevant data from an online database to populate the Modules like Zotero does presently, or in a manner that is fully automated using just voice and artificial intelligence to populate fields in the Modules. There are many embodiments that allow Users to automate Module creation.

### Alternative Activation Phase:

The invention could be activated through a range of steps that are different to those set out in the preferred embodiment 306. A command other than “Hey Siri” could initiate the voice command sequence, which is the case for a number of other phone operating systems, computers and voice-activated home assistants. In addition, Users could configure their devices to activate voice recognition by pressing a single button on the headphone, cell phone, smart watch or computer 306. This allows Users to initiate record-taking using a single touch, in this preferred embodiment, on a set of Bluetooth headphones. On some of these devices, a button or icon can also be designated to run a particular Module directly, dispensing with the need to say the voice activation word like “Hey Siri” or its equivalent, followed by “Vocal-Brothers Karamazov” or some other trigger name that the User has assigned to the Module. In addition, pressing the button on an iPhone lock screen or on a computer could run the Brothers Karamazov Module immediately. Users could also activate a Module directly like this within the invention by assigning the Module a particular keystroke or key combination on a keyboard 306. This option would allow Users to automatically start a particular Module like Brothers Karamazov with a keystroke, such that they could dictate information into a database as they are working on a laptop without switching applications on their laptop to do so.

### Alternative Input Phase:

The invention's Input Phase has many alternative embodiments. For instance, a User can use a generic Module that allows them to enter each and every field each time they enter a record, which would avoid the need to create specific Modules that are given a different and specific trigger name that points directly to the particular source it always references. So, instead of creating a Module for all records about Fyodor Dostoevsky's Brothers Karamazov, the User could trigger a generic Module for audiobooks, then dictate “Fyodor Dostoevsky” into the author field when prompted by the invention, then dictate “Brothers Karamazov” into the title field when prompted. This alternative avoids having to create a specific Module, and couples well with automated incorporation of metadata including through the use of artificial intelligence.

Another alternative embodiment involves modifying the Question Prompts and corresponding dictation opportunities to record different sorts of information. For example, Users could choose to make records that require more, fewer or different question prompts. Instead of asking for just the User's notes on Brothers Karamazov, for example, successive question prompts could also ask about people the User thinks might be interested in this information, tags referencing the subject-matter covered by the note, social media accounts to post the information to, dates that act as a deadline for the User to follow up about this note, the medium that the underlying information originally appeared in such as audiobook, podcast, ebook etc, the name of the publisher, and many other possibilities.

Another alternative embodiment involves modifying the questions and corresponding dictation opportunities so that the invention performs different functions, other than acting as a note-taking device about audiobooks as in our preferred embodiment. That the invention has a far wider range of applications is clear from FIGS. 1-5 included in this patent application. To mention only a few, we have built a variation of the invention so that it allows Users to create notes-to-self, social media posts, emails containing several data fields and texts using just the User's voice. By modifying the questions and dictation queries in this way, a User can create structured data records for a range of purposes using their voice.

Another alternative embodiment in the input phase would give Users the ability to manually confirm the end of an input prompt, rather than using silence to automatically end a dictation. Although this modification would require some physical interaction with the phone, smart watch, or other type of computer that is running the invention, it would allow Users to take their time formulating the content of their notes, without having them worry that the invention will move on to the next question before they are able to collect and express their thoughts. In this way, Users can customize the Input Phase in a variety of alternative ways to best suit their needs and the nature of the information they are creating records about using their voice.

### Alternative Transmission Phase:

The invention's Transmission Phase has numerous alternative embodiments too. For instance, the invention could couple with a wide variety of External Platforms 110. Although our preferred embodiment connects with Notion, other online databases such as Obsidian, Markup, Monday, Google Sheets and others can perform similar functions 203. Our invention can transmit audio and/or text to any online database that has a public-facing API and to others that can receive information via email or text. Likewise, the invention could create its own database system to transmit records to and store records in, rather than relying on third parties.

Another alternative embodiment of the transmission phase involves transmitting the information the invention produces via email or text 210, 504. In this alternative embodiment, a User could create certain dictation fields so that dictated information populates the subject line of an email, then have other dictated text fill the body of an email, using just the User's voice. Users could also include tables of their records, mindmaps, quizzes and other materials in text messages or email that they send 506. The emails or text messages could be sent to the User as a reminder, or to groups of people operating as a team, all without the User using a keyboard or accessing a screen. These texts and emails could be sent to individual Users or directed towards online communication systems like Slack.

Another alternative embodiment of the transmission phase involves transmitting the information directly to social media channels 210, 504. As was the case with email and text, Users could transmit different fields of text and audio to social media channels using only their voice. For instance, a User could dictate text to include alongside a URL of a website source in Twitter. The URL could be incorporated in the note as automatic information, combined with the dictated text, then posted directly to Twitter. Alternatively, Users could choose to post the audio file of their dictated message alongside an image obtained as Automatic Information onto Facebook, LinkedIn or Instagram 110. A number of embodiments of this invention facilitate voice-based interface with social media in other ways too.

Another alternative embodiment of the transmission phase involves transmitting the information directly to websites 212, 504. Users can configure Modules to transmit dictated records directly to a range of websites, either as HTML directly into the body of a webpage or as text and imagery that is private to the User on a web platform like Obsidian, Google Docs, Notion or some other equivalent service. The invention could also perform multiple forms of transmission simultaneously, sending the same information to a plurality of locations and platforms at the same time.

### Alternative Ending Phase:

An alternative embodiment of the ending phase could involve opening a new application instead of returning to where the User activated the invention. For example, after entering a record, the invention could open the database that relates to the record just entered for the User to verify whether the dictation was entered accurately and/or to append other information by manual entry. Alternatively, the invention could take the User to a draft email that contains the table of records, dictated text or other information generated by the invention, so that the User can verify accuracy or modify entries before sending. These alternatives are most useful when the invention is used in conjunction with a laptop or desktop computer, but they have a wider salience too.

### Alternative Retrieval Phase:

There are multiple alternative embodiments of the invention in the Retrieval Phase, as demonstrated by FIGS. 4a-4b and FIG. 5. Importantly, the retrieval system need not depend on the invention's methods for acquiring information—the retrieval system could operate in conjunction with any database of information, offering unique and non-obvious data management and retrieval methods for dataset that are created independently of this invention. As this patent application shows, Users have significant choice in how they retrieve records along two core axes, namely Audio Retrieval 502 and Visual Retrieval 503.

For Audio Retrieval 502, there are myriad alternative embodiments other than activating records about Russian authors by pushing a button in an email reminder, as was our preferred embodiment above. Alternatively, the User might initiate the Voice Retrieval system independently of reminders 508 or accept an invitation to review audio records that is issued by a robocall that the User pre-arranged 209, 508. If the User initiatives the Voice Retrieval system by themselves independently of the reminder system, the User could specify a precise record they are looking for, like “The note I made when I was in Geneva last year about the history of Protestantism is Europe.” The User could relisten to the dictated note, then choose to retransmit it to Facebook, Twitter and Linkedin using voice 512. There are numerous other alternative embodiments for Audio Retrieval, as outlined in FIGS. 4a-4b and FIG. 5.

Likewise, for Visual Retrieval 503, instead of choosing to have the User's notes on The Brothers Karamazov sent to the User at regular intervals, the User could have notes-to-self that were created that day sent to their team via Slack at the end of the day, or all notes involving Russian authors uploaded to a public facing webpage at the end of each year, or a mindmap summarizing excerpts the User made of the book posted to Facebook, or a quiz of twelve questions about Dostoevsky's complete works sent to a quiz function within the app. There are numerous other alternative embodiments for Visual Retrieval, as outlined in FIGS. 4a-4b and FIG. 5.

In an embodiment, the system can be set up to allow the creation of specialized Modules that do not require the User to dictate any information. These Modules can be configured to capture only predefined automatic information, such as the time, date, author name, an excerpt of the audio, and the timestamp of the audio location. This configuration is particularly useful in scenarios where users may not be able to or prefer not to dictate, such as when they are at the gym, on a crowded bus, or in any noisy environment. To implement this, the Module setup process can include an option to disable dictation prompts and instead enable a selection of automatic data attributes to be captured whenever the Module is triggered. The Module can still perform the regular activation and transmission phases, but it would automatically generate a note with the specified automatic information without requiring any user input beyond the initial trigger. This functionality provides flexibility and convenience, allowing users to effortlessly capture notes without having to speak.

In an embodiment, the system can also be configured to include an option for capturing screenshots of visual material being displayed on the application playing audio information. This feature is particularly beneficial for users who are consuming video content or other visually rich media and want to capture specific visual elements as part of their notes. To implement this, the Module setup could include a checkbox or toggle to enable “Screenshot Capture Mode.” When this mode is enabled, the system, upon Module activation, would take a screenshot of the current screen of the application playing the audio and automatically add this screenshot to the note created. The screenshot would be stored alongside other captured data such as audio excerpts, timestamps, or other metadata. This approach allows users to combine both audio and visual information in their notes, enhancing the richness and utility of their records for later review or study.

One advantage is that this invention provides Users with an improved ability to create structured records, made up of different segments of information, using just their voice and not a keyboard or screen to do so.

Another advantage of the invention is that Users are better able to send dictated records to a variety of different destinations automatically, including email clients, text messengers, social media apps, web-based databases, or a combination of them.

Another advantage of the invention is that Users can more easily dictate notes-to-self as one type of dictated record. These notes-to-self can automatically include a range of information in addition to what User's dictate, such as date, geo-location and subject headings.

Another advantage of the invention is that Users can more easily dictate social media posts, which can be posted to various social media platforms together with a URL using just voice commands.

Another advantage of the invention is that it better allows Users to take structured notes that are automatically organized into an online database using just their voice while listening to audiobooks, podcasts, online videos, text-to-speech apps and other forms of audio information.

Another advantage of the invention is that it better allows Users to add a range of automatically generated information to their dictated records, including but not limited to, the User's name, the date and time the record was created, a geo-location of the place where the record was created, a screenshot of the app producing audio at the moment the invention is triggered, a URL of the source information the record is about, the name of the author of the source information, the title of the source information, the full citation of the source information, a timestamp for the position in an audio file the User is listening to when the App was triggered, and capture of an excerpt of the audio playback the User is listening to in audio and text formats.

Another advantage of the invention is that it better allows Users to create question prompts that allow the User to more consistently dictate the right information at the right time, so that dictated records can be added to the correct columns in a database, a text message, an email or a social media post.

Another advantage of the invention is that Users can either create their own customized question prompts or select from a range of pre-prepared question prompt templates that are tailored to the type of information the User is dictating information about, such as audiobooks, videos, music, notes-to-self, and social media posts.

Another advantage of the invention is that Users have greater choice in how question prompts are created and work, by allowing the User to choose to enter question prompts using their own voice or to have text-to-speech technology read the questions based on text the User types.

Another advantage of the invention is that Users can better capture excerpts of the audio they are listening to as an audio file and/or as text within a dictated record with a simple spoken command, button press, or key combination, without having to add further comments to the record, use a keyboard or see a screen.

Another advantage of the invention is that it allows Users to create, edit, duplicate, search, delete and share dictation modules. Each dictation module contains different question prompts, automatic information and output destinations that are tailored to a User's many different needs.

Another advantage of the invention is that it better allows Users to avoid having to re-state information that is common to many dictated records they are making using their voice. For example, the invention better allows Users to include metadata about a source they are dictating records about, such as the author's name or title of a book. This information is automatically included in a dictated record without the User having to dictate it each and every time they make a note about the book.

Another advantage is that the User can create as many or as few data fields that will be transmitted as part of the structured data record into an organized form within an online database, to a webpage, or via other mediums such as text, email or social media.

Another advantage is that the invention can be set to automatically input certain fields of the structured data record, obviating the need for the User to listen to the corresponding question or dictate the data repeatedly. This embodiment speeds up the note-taking process.

Another advantage of the invention is that it better allows Users to choose how to end their dictation of records, including by: (a) pausing dictation for a period; (b) pressing a button on a phone, headset or computer; or (c) having the User say a pre-selected phrase.

Another advantage is that Users can choose from a variety of ways to start dictating a record, including by: (a) making dictated records every time the User speaks; (b) creating a trigger word the User can say to commence record-taking; (c) creating a button the User can push on a phone or computer to commence record-taking; or (d) creating a keystroke or key combination the User can press on a keyboard to start record taking.

Because Users can run a particular module within the invention by using a voice trigger, they can dictate and store information while standing, working, exercising, walking or running without using a keyboard or opening their phone. This is a significant advantage over prior art.

Because Users can dictate information by using a button trigger, they can start the invention by pressing a button on their phone's lock screen or computer dashboard then dictate and store organized structured data immediately. This is a significant advantage over prior art too.

Because Users can set up a key combination to trigger the App, they can start the App by pressing a combination of keys on their computer, then dictate organized structured data immediately without switching out of the active software application.

Another advantage is that Users can more easily set up connections within the App to web-based databases to store their dictated records, such as Notion, Google Sheets, Airtable and Monday. In one iteration, Users can have the invention set up the databases automatically for them.

Another advantage of the invention is that it better allows Users to make dictated records using just their voice, without first unlocking their phone. Users can also dictate records using their voice on a computer, without first opening an App on their computer. Both features are an improvement on prior art.

Another advantage of the invention is that Users can use many different devices to input structured data records using their voice. To offer some non-exhaustive illustrations, Users can input structured data records with their voice via headphones, cell phones, smart watches, home voice assistants, or a computer microphone.

Another advantage of the invention is that it provides Users with multiple ways of transmitting structured data records using their voice. These records can be transmitted using an Application Programming Interfaces (API) or they can be sent using email, text or other means. The various transmission options are not mutually exclusive, so Users can choose several, even for the same organized structured data record.

Another advantage of this invention is that this system better allows Users to choose multiple destinations for their notes, thereby affording Users with a greater number of means of accessing, searching, retrieving, processing, organizing, displaying and sharing their structured data records that were created using voice.

Another advantage of the invention is that it better allows Users to dictate records about audio information they hear playing on a variety of different platforms, such as the Audible app, Apple Podcasts, and Youtube. The invention is a stand-alone program that works with a wide array of audio programs, which is an advantage over programs that connect with only one audio provider.

Another advantage of the invention is that it better allows Users to capture excerpts of background audio the User was listening to and include the excerpt as part of the dictated records. This advantage includes the ability for Users to stipulate the duration of audio to capture excerpts of as part of dictated records and a choice to capture the excerpt as text and/or audio.

Another advantage of the invention is that it better allows Users the ability to choose between automatically capturing a constant duration of audio they were just listening to as part of a dictation record, or to have the App ask them how much audio to capture each time they dictate a record.

Another advantage of the invention is that it offers Users a clearer and more immediate confirmation that the dictated record was successfully completed. The invention more clearly lets the User know that an error occurred in attempting to dictate a record, what the nature of the error is, and how to remedy it. In one embodiment, the invention speaks these error messages.

Another advantage of the invention is that it better ensures that dictating a record automatically suspends background audio playback during the dictation process then resumes playback after the dictation process is complete, so that Users can dictate records handsfree, without manually stopping and starting audio sources.

Another advantage of the invention is that it better allows Users to choose from an array of retrieval, presentation and testing methods in order to promote their revision, retention and learning of the information contained in dictated records. These methods include voice commands to search for, retrieve, present and share dictated records in a variety of different ways.

The invention better allows Users to email or text dictated records instantaneously, at a particular time, or at regular intervals. The invention also allows Users to more easily post dictated records made up of dictated text and a URL to Social Media, including Twitter, Facebook, Linkedin and Instagram.

Another advantage of the invention is that it allows Users to more easily search for, retrieve, listen to and review audio versions of their dictated records as well as excerpts of audio playback that they captured as part of their records, something like reviewing phone messages in voicemail.

Another advantage of the invention is that it allows Users to automatically create mindmaps about their dictated records then have these mindmaps sent to them by email or text immediately, at a particular time, or at regular intervals, to promote their revision, retention and learning of this information.

Another advantage of the invention is that it allows Users to automatically create quizzes about their dictated records, then have the invention ask questions, receive answers and reply to the User's answer. The invention can also better remind the User about the need to sit these quizzes by email, App notifications or via a robocall as the User desires.

Another advantage of the invention is that once it places organized structured data records within an online database, these notes can be more easily accessed, searched, retrieved, processed, organized, displayed and shared with other platforms, devices and people than other types of notes.

Another advantage of the invention is that it more easily allows Users to automatically pause then restart audiobooks, podcasts, online videos, text-to-speech apps and other forms of audio information they are listening to while the User makes a note using their voice.

Another advantage of the invention is that it better enables Users to multitask while listening to various forms of audio information by allowing them to take notes about the audio information they are listening to without using their hands much or at all.

Another advantage of the invention is that it better allows Users to enjoy greater mobility while listening to audio information and taking notes about that information. Users can, to mention a non-exhaustive set of illustrations, walk, run, clean or drive while absorbing, creating and managing information using their voice and this invention.

Another advantage of the invention is that it better promotes the physical and mental health of Users by allowing them to exercise while working or learning rather than sitting. Users can, to mention a non-exhaustive set of illustrations, sit on exercycles, walk on treadmills, and exercise in the outdoors while absorbing, creating and managing information using their voice and this invention.

Another advantage of the invention is that it provides Users with reading difficulties, such as the blind, those with dyslexia or those who are illiterate, with increased ability to take notes on audio information. This advantage provides these people with more capacity to absorb, create and manage their notes about audio information, and therefore more ability to work and learn using audio.

Data transformation rules are a set of guidelines that define how the system should modify or convert the user utterance from its original (source) format into the target format required by the system associated with the output destination. This transformation process could involve changing the data structure, encoding, or even the nature of the data to ensure compatibility with the system associated with the output destination. For instance, if the system is designed to receive a spoken utterance and then transmit it as text in a specific format, such as XML or JSON, the data transformation rules would specify the steps involved in converting the spoken words into text and structuring the text according to the format required by the system associated with the output destination.

Data mapping specifications, on the other hand, outline how the data fields within the user utterance, or any other input data, are mapped from the source fields to the target fields in the system associated with the output destination. This ensures that the data is placed in the appropriate sections of the destination format. For example, if the source data contains fields such as “SpeakerName” and “MessageText,” and the system associated with the output destination requires fields labeled “UserID” and “TextMessage,” the data mapping specifications would define how the system maps “SpeakerName” to “UserID” and “MessageText” to “TextMessage.”

In addition to defining the transformation and mapping processes, the system may also be configured to receive these data transformation rules and data mapping specifications based on a detected trigger. Alternatively, these rules and specifications could be pre-configured and retrieved from memory as needed based on the trigger, or provided by a user. For example, if the system detects a certain voice command (trigger), it can retrieve the relevant data transformation rules needed to convert the user utterance into a target format suitable for the system associated with the output destination, as well as the corresponding data mapping specifications to ensure the correct placement of data in the destination format.

Data transformation rules and data mapping specifications can be received from an output destination using an API (Application Programming Interface). In this process, the system can be configured to request specific data transformation rules from a remote website or server via an API. The system sends an API request with relevant parameters, such as the format of the user utterance and the desired destination format. The API then responds with the transformation rules necessary to convert the data into the target format. For instance, if the system needs to convert a spoken user utterance into text formatted in JSON, the API would provide rules on how to handle the conversion, including encoding, structuring, and formatting the data according to the requirements of the output system.

Similarly, data mapping specifications can also be retrieved through an API. In this case, the system requests the mappings between source fields and target fields from the API, and the API responds with the appropriate mappings. For example, when the system handles user utterances that need to be mapped to specific fields in a system associated with the output destination (such as mapping “SpeakerName” to “UserID” and “MessageText” to “TextMessage”), the API provides the necessary mappings to ensure proper alignment of the data in the output format.

Using an API for data transformation rules and data mapping specifications allows the system to perform real-time retrieval of these elements, enabling dynamic adaptation based on the specific context of the detected trigger. This makes the system highly flexible, as it can dynamically call the API to retrieve the needed rules and specifications tailored to the data and output destination at that moment. For example, if the system detects a trigger indicating a specific output destination, it can use the API to retrieve the corresponding transformation rules and mapping specifications to ensure seamless data transmission and compatibility with the destination.

The system can incorporate a translation feature for user utterances, associated data, or any other audio, visual, or textual data received by the system. This functionality enables the system to automatically generate and transmit translations to the output destination.

To implement this, the system's memory would be updated with additional instructions that configure the processing circuitry to perform several steps. Upon receiving a user utterance or associated data, the system checks whether translation is required based on user preferences or the detected trigger. Alternatively, translations are always generated. It can utilize translation methods including, but not limited to: manual translation, where users or administrators input translations directly; automatic machine translation, where the system integrates with machine translation services (such as Google Translate) to generate translations; or AI-generated translation, where advanced AI models are used to provide contextually accurate translations based on natural language processing, ensuring that the nuances and intent of the original utterance are preserved.

In an embodiment, the need for translation is determined by the detected trigger. Different triggers may prompt translations into specific languages or formats. For example, a voice command in one language may trigger a translation into another language. Once the translation is completed, the translated user utterance or associated data is transmitted to the output destination. The system is also configured to save translated data for future retrieval, which could be stored in a database, cloud storage, or another repository, allowing users to access translations at a later time.

Additionally, the system can handle multiple languages. It can either recognize the language of the user utterance, associated data, or other audio/visual/textual data received by the system or rely on predefined user settings to select the appropriate translation service or model based on the target language and the specific output destination.

The translation functionality offers several key advantages. First, it enhances accessibility by allowing the system to be more inclusive for a global user base, enabling communication in users' native languages, regardless of the system's default language. Additionally, real-time translation, whether through automatic machine translation or AI-generated methods, ensures timely communication, minimizing delays in delivering information to the output destination.

AI-generated translation, in particular, brings a more sophisticated approach by preserving nuances, idiomatic expressions, and contextual meaning, resulting in a more accurate representation of the original data. The system also boosts communication efficiency by reducing the need for manual translation, automatically translating data based on triggers, which is especially beneficial for users communicating across different languages or systems with varying data formats.

Methods in this document are illustrated as blocks in a logical flow graph, which represent sequences of operations that can be implemented in hardware, software, or a combination thereof. In the context of software, the blocks represent computer-executable instructions stored on one or more computer storage media that, when executed by one or more processors, cause the processors to perform the recited operations. Note that the order in which the processes are described is not intended to be construed as a limitation, and any number of the described method blocks can be combined in any order to implement the illustrated method or alternate methods. Additionally, individual blocks may be deleted from the methods without departing from the spirit and scope of the subject matter described herein.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions (or a computer-implemented method) may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. It should be appreciated that any method steps described within this document can be performed automatically and/or in real-time and/or in near real-time.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

I claim:

1. A system for transmitting data to an output destination, the system comprising:
a processing circuitry;
a memory, the memory containing instructions that, when executed by the processing circuitry, configure the system to:
detect a given trigger from a plurality of triggers;
when the given trigger is detected:
receive at least one of a user utterance and an associated data;
transmit the at least one of a user utterance and an associated data to the output destination;
wherein
the output destination is based on the detected trigger.

2. A method of transmitting data to an output destination, the method comprising:
detecting a given trigger from a plurality of triggers;
when the given trigger is detected:
receiving at least one of a user utterance and an associated data;
transmitting the at least one of a user utterance and an associated data to the output destination;
wherein
the output destination is based on the detected trigger.

3. The method of claim 2, further comprising steps of:
when the given trigger is detected:
providing at least one prompt to the user;
wherein
the at least one prompt is provided based on the detected trigger; and
the user utterance is received in response to the at least one prompt.

4. The method of claim 2, further comprising steps of:
when the given trigger is detected:
generating at least one associated data;
transmitting the at least one associated data to the output destination;
wherein
the at least one associated data is generated based on the detected trigger.

5. The method of claim 2, further comprising steps of:
receiving at least one of data transformation rules and data mapping specifications, wherein
the data transformation rules outline how to transform the at least one of a user utterance and an associated data to a target format of the output destination;
the data mapping specifications outline how to map the at least one of a user utterance and an associated data from source fields to target fields in the output destination;
wherein
the data transformation rules are received based on the detected trigger; and
the data mapping specifications are received based on the detected trigger.

6. The method of claim 5, further comprising steps of:
transforming the at least one of a user utterance and an associated data from the source format to the target format of the output destination.

7. The method of claim 2, further comprising steps of:
configuring the plurality of triggers, wherein
each of the plurality of triggers is associated with:
at least one prompt to provide to the user;
at least one associated data to be generated; and
an output destination.

8. The method of claim 2, wherein
the given trigger is an audible command from the user.

9. The method of claim 2, wherein
the given trigger is a manual interaction with the system.

10. The method of claim 2, further comprising steps of:
detecting a given retrieval trigger from a plurality of retrieval triggers;
when the given retrieval trigger is detected:
retrieving the at least one of a user utterance and an associated data from the output destination;
wherein
the output destination is based on the detected retrieval trigger.

11. The method of claim 10, further comprising steps of:
configuring the plurality of retrieval triggers, wherein
each of the plurality of retrieval triggers is associated with:
an output destination.

12. The method of claim 10, wherein
which user utterance or which associated data is retrieved from the output destination is based on retrieval criteria provided by the user.

13. The method of claim 10, further comprising steps of:
aggregating at least two retrieved user utterances or retrieved associated data into a set of user utterances and associated data.

14. The method of claim 13, further comprising steps of:
playing, via an audio device, the contents of the set of user utterances and associated data.

15. The method of claim 13, further comprising steps of:
generating, using a machine learning model, a test or summary based on contents of the set of user utterances and associated data; and
playing, via an audio device, the test or summary.

16. The method of claim 10, further comprising steps of:
transforming the retrieved user utterance or associated data into text format.

17. The method of claim 16, further comprising steps of:
displaying, via an electronic display, the retrieved user utterance or associated data in text format.

18. The method of claim 2, further comprising steps of:
detecting an automatic retrieval condition;
when an automatic retrieval condition is detected:
automatically retrieving the at least one of a user utterance and an associated data from the output destination;
wherein
the automatic retrieval condition is set by the user.

19. The method of claim 18, wherein
the automatic retrieval condition is a set time.

20. A non-transitory computer readable medium having stored thereon instructions for causing a processing circuitry to execute a process, the process comprising:
detecting a given trigger from a plurality of triggers;
when the given trigger is detected:
receiving at least one of a user utterance and an associated data;
transmitting the at least one of a user utterance and an associated data to the output destination;
wherein
the output destination is based on the detected trigger.
